(19) United States
(12) Patent Application Publication
(10) Pub. No.: US 2015/0307377 A1
(43) Pub. Date: Oct. 29, 2015

(54) PROCESS FOR MAKING WATER DRINKABLE

(71) Applicant: ROQUETTE FRERES, Lestrem (FR)

(72) Inventors: Laura CROWTHER-ALWYN, Armentieres (FR); Anne-Chantal HERRENG, Le Maisnil (FR); Celine POTTIER, Perenchies (FR); Regis HOUZE, Tourmignies (FR)

(21) Appl. No.: 14/443,106

(22) PCT Filed: Nov. 18, 2013
(86) PCT No.: PCT/FR2013/052762

§ 371 Date: May 15, 2015

(30) Foreign Application Priority Data
Nov. 16, 2012 (FR) 12 60911

(51) Int. Cl. C02F 1/52; C02F 1/54

(52) U.S. Cl. CPC C02F 1/5245; C02F 1/54; C02F 2103/28

(57) ABSTRACT

A process for making an aqueous solution containing solids in suspension drinkable, includes a coagulation-flocculation step, which includes the steps of: a) adding coagulants to the aqueous solution to be treated; b) stirring the aqueous solution to which coagulants were thus added; c) separating the coagulated solids by settling out or flotation; d) recovering purified water; wherein the coagulants added in step a) include metal salts chosen from ferric salts and aluminum salts, and also a liquid starchy composition including a cationic waxy starch, the cationic starch having, when it is placed in the form of an aqueous composition, a viscosity, measured according to a test A, greater than 100 mPa·s and less than 1000 mPa·s, this test A consisting in adjusting the dry weight of cationic waxy starch of the aqueous composition to 10% and then measuring the Brookfield viscosity at 25° C. of the resulting composition.

The invention relates to a process for making water drinkable, in particular a process comprising a step of coagulation-flocculation using, in combination with a metal salt, a liquid composition of a particular dissolved cationic starch.

In the water sector, treatment processes are very diverse: for example, before being discharged into the environment, urban wastewater or water from an industrial circuit are treated differently.

For example, as regards drinking water, it is necessary to obtain a water of high purity after the process. Since its distribution is a subject of prime concern for human populations, increasingly draconian regulations have been imposed over the years. The high purity of this water is achieved by using very specific processes, which are quite different from other water treatment processes in which the purity of the water obtained may be inferior.

To obtain a drinking water, it is possible to pump an aqueous solution of a ground water or of a surface water that is to be treated, such as a lake water or a watercourse water. This aqueous solution always comprises a more or less large amount of particles in suspension, which it is necessary to remove.

For example, as regards coarse particles, generally greater than 1 mm, they may be removed during a preliminary step by passing the aqueous solution through grilles. This step is also known as the “screening step”.

The finer particles in suspension may also be removed by separating them from the aqueous solution to be treated, for example by decantation or by flotation.

Decantation consists in leaving the solution to settle in a decantation tank, also known as a “decanter”, so that the particles in suspension settle to the bottom of this tank. The purified water is thus recovered by overflow.

As regards flotation, the principle of this technique is to mix in a floater the aqueous solution with air, so as to recover the particles at the surface. The water thus treated is recovered at the bottom of the floater.

However, the aqueous solution generally comprises fine particles which are particularly difficult to separate out, in particular colloidal particles of very small size, generally ranging from 1 nm to 1 μm.

In order to separate out these fine particles more easily and more quickly, a coagulation-flocculation step is first performed. This step consists in agglomerating the particles in suspension: these coarser agglomerated particles are then separated out more easily and more quickly via the separation treatments mentioned previously.

To perform the coagulation-flocculation, coagulants and flocculants are used, alone or as a mixture. These agents may be chosen from iron or aluminum salts, anionic or cationic polyacrylamides and nonionic, anionic or cationic starches.

Generally, the coagulant and the flocculant are mixed in two separate steps with the aqueous solution to be treated in a tank, referred to in the present patent application as the coagulation-flocculation tank. This tank generally consists of a first basin known as the “coagulation basin” and of a second basin known as the “flocculation basin”, into which are introduced, respectively, the coagulant and the flocculant. These coagulation phenomena are generally explained by destabilization of the particles, in particular of colloids, and flocculation by aggregation of these particles thus destabilized. Next, the aqueous solution comprising the agglomerates of particles or of colloids, known as flocs, undergoes a separation step: sludges consisting of agglomerated flocs and a purified water are thus recovered.

To measure the efficacy of this coagulation-flocculation step, measurement may be made of the chemical oxygen demand (COD) of the purified water, which is an indirect measurement of the concentration of organic or mineral matter, dissolved or in suspension in this water: the amount of oxygen required for the total chemical oxidation of this matter is measured. Measurement of the amount of organic carbon dissolved in the treated water may also be performed.

Alternatively, measurement may also be made of the level of cloudiness of the aqueous solution, also known as the turbidity, before and after this coagulation-flocculation step.

This turbidity is measured with a nephelometer (also known as a turbidimeter) and is measured in nephelometric turbidity units (NTU).

The reduction of the turbidity is thus determined, which may be expressed as a percentage.

Another means is also to measure the absorbance of the treated aqueous solution at a given wavelength.

Furthermore, in order to make a water drinkable, the water thus purified is generally subjected to a “filtration step” which consists in passing the water through one or more filters in order to remove certain residual pollutants. A disinfection step may also be performed, which consists in adding an agent or in using a treatment that is capable of eliminating the bacteria present in this water. The latter treatments are particularly useful in a process for making water drinkable.

Water treatment processes are generally continuous processes.

In the case where a filtration step takes place in order to make the water drinkable, the final particles remaining in suspension are removed from the aqueous solution by passing through filters. During this filtration, the particles are thus accumulated inside filters and these filters become clogged. A “loss of pressure” then takes place, i.e. a loss of flow rate of filtered water at constant pressure applied to the filter. In order not to have to increase the pressure in order to keep the flow rate constant and not to have to stop the process too frequently in order to change or clean the clogged filter, the aqueous solution to which this filtration step is applied must have a low turbidity, generally less than 1.5 NTU and preferentially less than 1 NTU.

Similarly, to perform a disinfection step, it is advantageous for the water to be as clear as possible, in order to facilitate this disinfection step (reduction of the required amount of agent or lower intensity of the disinfection treatment).

Furthermore, the national regulations generally impose, for the distribution of a drinking water, a low turbidity. For example, in France, this turbidity must be less than 1 NTU.

Thus, reduction of the turbidity obtained during the coagulation-flocculation step is very important in a process for making water drinkable.

Processes for treating drinking waters using agents based on cationic starch have already been described. Specifically, these cationic starches have the advantage of being manufactured from renewable plant resources and of being available in large volumes.

As an example of a process for making water drinkable, mention may be made of patent U.S. Pat. No. 5,543,056, which describes a process in which the aqueous solution is supplemented with a coagulant, which may be cationic starch, and a flocculant, which is a clay. Said patent also describes in the comparative tests a process for making water drinkable using metal salts as coagulant in a first step, and a flocculant chosen from chitosan or polyacrylamides in a second step.

Mention may also be made of document US 2004/0 026 657, which describes a clarification process using a primary coagulant, which is a mineral salt, an anionic or nonionic flocculant, a cationic coagulant, which may be a cationic starch that is at least partially insoluble, a disinfectant, a water-soluble base, a water-insoluble silicate and additives. One problem of this very particular process is that the cationic starch and the mineral salt used do not make it possible to obtain an excellent reduction in turbidity.

There is at the present time still a need for novel processes for making water drinkable.

In particular, it would be advantageous for this process to be able to be performed using a rapid treatment time, using a small amount of chemical products, and without needing to modify the installations conventionally used for these treatments. It should make it possible to greatly reduce the turbidity of the water treated.

The Applicant has already found a process for making water drinkable that makes it possible to solve the abovementioned problems, this process forming a subject of French patent application FR 1 156 702 and international patent application PCT/FR2012/051 714, these two patent applications not having been published to date; said process uses as coagulant products that are useful in the invention a metal salt and a particular liquid starchy composition. Specifically, the starchy composition that is useful in the invention must have a relatively high viscosity, since it must have a Brookfield viscosity at 25° C. at least equal to 1000 mPa·s, this viscosity being measured at 10% solids.

In general, and in particular for products that are useful for water treatment, coagulant products are generally supplied to the user clients in the form of concentrated liquid solutions with a high solids content, especially solutions with solids contents that may be up to 80%. Since the solids content of these solutions is high and the amounts of solvent are low, this allows the manufacturer to supply solutions that can be readily stored and/or transported. As regards the user client, it suffices for him to use these concentrated solutions, optionally after simple dilution. Now, in the case of a starchy liquid composition, one of the problems is that by increasing the content of starch solids, the viscosity of the composition increases. It may even take a pasty or gelled consistency, which makes it difficult to manipulate and thus to dilute. It is therefore necessary for this concentrated composition to be in sparingly viscous liquid form. Now, the drawback of the process that was the subject of patent application PCT/FR2012/051 714 is that the starchy composition that is useful in the invention has a relatively high viscosity. For example, in the cases where the viscosity according to test A described in said patent application exceeds 500 000 mPa·s, it is necessary for it to have a solids content that will have to be considerably less than 5% in order to be liquid and in order thus to be able to be handled easily, for example by pumping, or in order to be able to dilute it.

The Applicant has been able, by performing studies relating to processes for making water drinkable, to perform a novel process for making water drinkable which makes it possible to drastically reduce the turbidity of an aqueous solution comprising solids in suspension.

Specifically, the Applicant has found that a liquid composition of cationic starch having specific characteristics makes it possible, when it is used in a coagulation-flocculation step together with a ferric salt and/or an aluminum salt, to particularly advantageously reduce the turbidity of the aqueous solution to be treated when compared with the cationic starches conventionally used in this field. This particular starch must be, during its introduction into the water to be treated, in a form dissolved in a liquid composition. This composition has the advantage of being able to have a high solids content, while at the same time remaining liquid and easy to handle. It may be used, with a metal salt, in any type of process for treating water or sludges, and in particular in a process for producing a drinking water comprising a coagulation-flocculation step.

In particular, one subject of the invention is a process for making drinkable an aqueous solution having solids in suspension, containing a coagulation-flocculation step, characterized in that said step comprises:

a) a step of adding coagulants to the aqueous solution to be treated;

b) a step of stirring the aqueous solution thus supplemented;

c) a step of separating out the coagulated solids by decantation or flotation;

d) a step of recovering a purified water;

and in which the coagulants added in step a) comprise metal salts chosen from ferric salts and aluminum salts and also a liquid starchy composition comprising a cationic waxy starch, said cationic starch having, when it is in the form of an aqueous composition, a viscosity, measured according to a test A, of greater than 100 mPa·s and less than 1000 mPa·s, this test A consisting in adjusting the cationic starch dry mass of the aqueous composition to 10% and then in measuring the Brookfield viscosity at 25° C. of the resulting composition.

Test A, used for measuring the viscosity of the cationic waxy starch, is applicable irrespective of the presentation form of the aqueous composition comprising it, be it liquid or pasty.

It consists in quantifying, via any standard method within the capability of a person skilled in the art, the cationic waxy starch solids content of said aqueous composition and, where appropriate, in diluting it with distilled water or in concentrating it via any suitable means not liable to significantly modify the cationic waxy starch it contains, so as to adjust the cationic waxy starch solids content of said composition to a value of 10%. After this, the Brookfield viscosity at 25° C. of the resulting aqueous composition is measured in a manner known per se. In other words, test A consists in measuring the viscosity of the cationic waxy starch and thus, obviously, in measuring the viscosity of a liquid composition consisting of 90% by mass of water and 10% by mass of dissolved cationic waxy starch. To concentrate the aqueous composition without modifying the starchy material comprising it, use may be made, for example, of a rotary evaporator.

Unless explicitly mentioned, it is indicated that the amounts of cationic waxy starch and metal salt are expressed as dry mass in the rest of the patent application.

The Applicant has found, surprisingly, that when it is used in a coagulation-flocculation step in combination with a metal salt, a liquid starchy composition comprising a cationic waxy starch having a viscosity of greater than 100 mPa·s and less than 1000 mPa·s when it is in the form of an aqueous composition, for a concentration of cationic waxy starch relative to 10% of the total mass of the aqueous composition, made it possible to obtain an exceptional reduction in the turbidity of a solution containing solids in suspension. This reduction could not be observed by the Applicant when a cationic starch composition of the same viscosity but not waxy is used in place of the abovementioned starchy composition.

According to a first variant of the process, the salts and the liquid starchy composition that are useful in the invention are added separately in step a).

According to a second variant of the process, the salts and the liquid starchy composition that are useful in the invention are added simultaneously in step a).

This addition may take place via a liquid composition M comprising both the dissolved cationic starch and the salts.

Advantageously, the viscosity of the cationic starch, measured according to test A, is between 150 and 990 mPa·s, preferably between 200 and 500 mPa·s and most preferentially between 205 and 450 mPa·s.

A waxy starch generally comprises amounts of amylopectin ranging from 90% to 100% by weight, for example ranging from 95% to 100% and very often ranging from 98% to 100%. This percentage may be determined by colorimetry by means of an iodine assay.

The cationic waxy starch may especially be obtained from corn, wheat, barley or potato. Most preferentially, the waxy starch is a waxy corn starch.

Preferentially, the metal salt is a sulfate, a polysulfate, a chloride, a polychloride or a polychlorosulfate. Preferentially, the metal salt is chosen from polyaluminum chloride and ferric chloride.

It may be added in step a) in the form of a liquid solution, for example having a concentration ranging from 0.01 to 1000 g/l, for example ranging from 0.01 to 150 g/l. The liquid of the solution may be any solvent for the metal salt, this solvent possibly being, for example, water. The pH of the liquid solution may range from 0 to 7, for example from 1 to 5.

When several metal salts are added in step a), it is pointed out that the amounts of metal salt are the total amounts of these various metal salts.

The process of the invention may be performed with a total mass amount of cationic waxy starch and of metal salt in the aqueous solution ranging from 1 to 500 mg/L of water to be treated. This amount is adapted to the initial water turbidity and it may advantageously be from 5 to 20 mg/L of water to be treated, preferentially from 5 to 10 mg/L.

It is particularly advantageous to perform the process with these small amounts of coagulant: this makes it possible to limit, firstly, the cost of the process and, secondly, the amounts of sludges consisting of coagulated matter in suspension to be removed. Furthermore, by selecting these amounts of coagulant, the metal salt remaining soluble in the water recovered in step d) remains low.

According to a first variant of the process of the invention, the cationic waxy starch/metal salt mass ratio may range from 15/85 to 70/30, for example from 15/85 to 60/40, advantageously from 15/85 to 55/45, preferentially from 20/80 to 50/50 and most preferentially from 25/75 to 40/60.

The Applicant has found that the coagulation-flocculation step is particularly effective when these coagulants are introduced in the above ratios.

The cationic starch may have a degree of cationic substitution of greater than or equal to 0.01, advantageously ranging from 0.018 to 0.3 and preferentially from 0.04 to 0.2.

The liquid starchy composition of cationic waxy starch introduced in step a) advantageously has a concentration of cationic starch ranging from 0.01 to 350 g/L, for example ranging from 0.01 to 50 g/L. The liquid of the composition may be any solvent for the cationic starch and is preferentially water.

The stirring step b) may be performed in the presence of an additional treatment agent, which may be chosen from algae, active charcoals and potassium permanganate. The treatment agent is preferentially active charcoal or potassium permanganate.

The duration of the stirring step b) may be greater than or equal to 1.5 minutes or more, preferentially ranging from 2 to 30 minutes and most preferentially ranging from 2.5 to 5 minutes.

The separation step c) may be a decantation step. This decantation step preferentially has a duration ranging from 0.25 to 1000 minutes, preferentially from 0.33 to 120 minutes and most preferentially from 0.5 to 12 minutes, for example from 1 to 5 minutes.

To further accelerate the coagulation-flocculation step, the flocs may be ballasted, for example with micros and.

Another advantage of the invention is therefore that the coagulation-flocculation step may thus be performed within a very short time.

According to the invention, the process may be continuous or discontinuous. When it is a continuous process, the durations of steps b) and c) are thus, respectively, the mean residence time of the aqueous solution to be treated in the coagulation-flocculation tank and in the decanter.

The process for making water drinkable according to the invention is particularly suitable when it comprises, subsequent to the coagulation-flocculation step, a step of filtering the purified water.

The aqueous solution comprising solids in suspension to be treated may have a turbidity of less than or equal to 1000 NTU, advantageously ranging from 2 to 300 NTU and preferentially ranging from 2.5 to 150 NTU, for example ranging from 3 to 100 NTU. This aqueous solution may be a surface water, for example a lake, stream or river water, or alternatively a ground water, which are the waters conventionally used for the purpose of transforming a water into drinking water.

The process is very advantageous for removing particles in suspension in the aqueous solution having a size ranging from 0.001 to 500 μm and in particular those ranging from 0.001 to 1 μm.

The turbidity of the purified aqueous solution thus obtained after step e) has a low turbidity, for example less than or equal to 1.5 NTU and preferentially less than 1 NTU.

According to the process of the invention, the reduction in the turbidity may be greater than 98%, advantageously greater than 98.5% and most preferentially greater than 99%. The process according to the invention makes it possible to greatly reduce the turbidity, which is very advantageous in a process for making water drinkable. These exceptional reductions in turbidity were able to be obtained in particular using surface waters or ground waters.

It should be noted that the reduction of the turbidity depends on the initial turbidity: using the process for a water of low turbidity, the reduction will not be as great as for a water of higher turbidity.

The turbidity may be measured using a WTW Turb 555IR machine sold by the company WTW.

The liquid starchy composition that is useful in the invention comprises a cationic waxy starch with a viscosity of greater than 100 mPa·s and less than 1000 mPa·s according to test A described previously. As will be outlined hereinbelow, this particular viscosity is directly linked to the cationic waxy starch used and to the process for preparing the composition, i.e. the dissolution of this cationic waxy starch.

As regards the cationic waxy starch, the viscosity of the aqueous composition of test A comprising it after dissolution depends on two main characteristics, in order of decreasing importance: its molecular mass and its degree of cationicity. These characteristics are readily selected by a person skilled in the art by choosing the botanical source of the native waxy starch and the conditions for preparing this cationic waxy starch.

The cationic waxy starch used in the context of the invention may be obtained from any type of native waxy starch of natural or hybrid origin, including starch derived from plant organisms that have undergone genetic mutations or manipulations. The waxy starch may especially be derived from waxy corn, from waxy potato, from waxy wheat or from waxy barley, preferentially derived from waxy corn.

The selection of this native starch has, for example, an influence on the final molecular mass and also on the amylose and amylopectin content.

For the cationic starch that is useful for manufacturing the starchy composition, in addition to a step of cationization of the starch, it is generally necessary also to perform a step for reducing the molar mass of the starch.

These two steps of molar mass reduction and of cationization may be performed in any order. Thus, the cationic starch that is useful in the invention may be obtained in a process comprising a first step of cationization followed by a second step of reduction of the molar mass of the cationic starch obtained in the first step. Alternatively, the cationic starch that is useful in the invention may be obtained in a process comprising a first step of reduction of the molar mass of the starch followed by a second step of cationization of the starch of reduced mass obtained in the first step. Use may also be made of a process in which the cationization step and the step of reducing the molar mass of the starch take place simultaneously.

The cationization reaction may be performed according to one of the methods well known to those skilled in the art, using cationic reagents as described, for example, in “Starch Chemistry and Technology”—Vol. II—Chapter XVI—R. L. Whistler and E. F. Paschall—Academic Press (1967). The starch is introduced into a reactor in the presence of these reagents.

Preferentially, the starch used in the cationization reaction is in a granular form.

The reaction may be performed in milk phase, the granular starch in suspension in a solvent being cationized using the temperature, time and catalysis conditions that are well known to those skilled in the art.

At the end of the reaction, the starch thus cationized may be recovered by filtration, and this cationic starch may then be washed and dried.

Alternatively, the reaction may be performed in the dry phase, i.e. in the presence of amounts of water added to the starch that are considered as low, for example in amounts of water of less than 20% of the mass of starch introduced for the cationization reaction, preferably less than 10%.

The reaction may also be performed in adhesive phase. The term “adhesive phase” means that the starch is at least partially dissolved, generally totally dissolved, in a solvent phase, said solvent phase generally being an aqueous phase or an aqueous-alcoholic phase. A cationic starch in the form of a liquid starchy composition is then obtained at the end of this process. It is also possible to obtain the cationic starch in solid form by drying the composition or by precipitation from alcohol or an aqueous-alcoholic solvent. Preferably, the cationization reaction is performed with nitrogenous reagents based on tertiary amines or quaternary ammonium salts. Among these reagents, it is preferred to use 2-dialkyl-aminochloroethane hydrochlorides such as 2-diethyl-aminochloroethane hydrochloride or glycidyltrimethyl-ammonium halides and halohydrins thereof, such as N-(3-chloro-2-hydroxypropyl)trimethylammonium chloride, the latter reagent being preferred. This reaction is performed in alkaline medium, at a pH above 8, or even above 10, the pH being able to be adjusted, for example, with sodium hydroxide.

The reagent contents used are chosen such that the resulting cationic starches have the desired degree of substitution (DS) of cationicity, the DS being the mean number of OH groups included on the anhydroglucose of the starch that have been substituted with a cationic group.

The step of reduction of the molar mass of the starch may be performed via any means, in particular chemical, enzymatic and/or physical, known to those skilled in the art and capable of allowing the direct or indirect production of a starchy composition having the appropriate viscosity according to test A. This step may be performed in solvent phase or in dry phase. This step may be conducted continuously or in batch mode, in one or more sub-steps, in a multitude of variants as regards the nature of the starch, the amount or presentation form of the modification means, the reaction temperature and time, the water content of the reaction medium or the nature of the starch (material already cationized or not yet cationized).

It may in particular be a chemical fluidization treatment, in aqueous medium or in dry phase, such as those mentioned or described in patent EP 902 037 in the name of the Applicant.

It may also advantageously be an enzymatic fluidization treatment (also known as enzymatic conversion or liquefaction), this treatment possibly being performed, for example, according to the teachings of patent FR 2 149 640 in the name of the Applicant. These enzymatic means include heat-stable or heat-unstable enzymes, such as alpha-amylase of bacterial, fungal or other origin.

It may also, likewise advantageously, be a treatment for efficiently converting the cationic starchy material, in an aqueous medium, by means of enzymes chosen from the group comprising branching enzymes (EC 2.4.1.18) and cyclodextrin glycosyltransferases or CGTases (EC 2.4.1.19). The branching enzymes may especially consist of starch or glycogen branching enzymes, isolated from algae or bacteria, such as those whose use is described in patents WO 00/18893 and WO 00/66633 in the name of the Applicant.

The Applicant Company has observed that the cationic starchy materials treated, before, during or after cationization, with a branching enzyme generally had a more improved stability on storage when compared with those treated with an alpha-amylase. Without wishing to be bound by any theory, the Applicant believes that this remarkable result is due, at least partly, to the fact that a treatment with a branching enzyme makes it possible to obtain hydrolyzed starchy materials that are more homogeneous, i.e. especially whose resulting constituent saccharides have molecular masses distributed on a Gaussian curve that is globally more uniform, more symmetrical and narrower than that obtained with an alpha-amylase. Preferably, the treatment with a branching enzyme is performed after the cationization step and it is moreover remarkable and surprising that the presence of cationic groups, of relatively large size, does not disrupt the oligosaccharide or polysaccharide chain transfer action of such enzymes.

The use of heat-stable enzymes makes it possible, if so desired, to perform enzymatic liquefactions at temperatures of the order of 90-100° C., these conditions being particularly advantageous for obtaining liquid starchy compositions that show good viscosity stability over time.

The modification treatment may also, by way of nonlimiting examples, make use of a fluidization combining acidic and enzymatic routes.

All the abovementioned means are applied to the starchy material, already cationized or otherwise, which is to be contained in the composition that is useful in the invention.

According to a preferred embodiment, cationization of the starch is performed in a first step, for example in milk phase or in dry phase, followed by a second step of reducing the molecular mass obtained in the first step via enzymatic conversion, this second step possibly being performed in solvent phase, preferentially in water. According to this preferred mode, a liquid starchy composition that is useful in the invention may be obtained directly.

A person skilled in the art will know how to adjust the reaction conditions of the step of reducing the molar mass and the cationization step of the starch so as to obtain cationic starches that make it possible to obtain the liquid composition that is useful in the invention. Specifically, it is necessary, during its manufacturing process, for the molecular weight of the starch not to be reduced excessively or, on the contrary, insufficiently: in other words, it is necessary for the molecular mass of the cationic starch to be reduced such that it has the adequate viscosity, i.e. a viscosity of between 100 mPa·s and 1000 mPa·s according to test A.

The Applicant markets such ready-to-use liquid starchy compositions.

The cationic starch may be soluble at room temperature in water. According to the invention, the term “soluble at room temperature” means that when the cationic starch is introduced at 10% by mass of water at 25° C. and is stirred for 1 hour, the starch solution thus obtained has a Brookfield viscosity of greater than 100 mPa·s.

If the cationic waxy starch used for preparing the starchy composition that is useful in the invention is in solid form, it is necessary to dissolve it in a solvent. The liquid starchy composition is generally an aqueous composition, which may mainly comprise water and optionally small amounts of water-miscible organic solvents, for instance alcohols such as methanol and ethanol, for example in amounts of organic solvent of less than 10% by mass relative to the total of the solvents.

To manufacture the liquid starchy composition that is useful in the invention, the cationic starch may be made soluble in the solvent by a cooking step if this starch is not soluble in cold water. This cooking is generally performed in water or an aqueous-alcoholic solution by suspending the cationic starch and thus forming a starch milk.

According to one variant, said liquid starchy composition is prepared using a cationic starch that is soluble at room temperature and by dissolving it in water, preferably with stirring. This variant is advantageous since the starch is thus readily dissolved in the liquid composition, without cooking. The composition that is useful in the invention may thus be readily used at the site performing the treatment process.

However, it is also possible to obtain directly, according to the processes described previously which comprise the steps of reducing the molar mass and of cationization, liquid starchy compositions comprising the cationic starch that is useful in the invention, i.e. in which the cationic starch has a viscosity, measured according to test A, which is greater than 100 mPa·s and less than 1000 mPa·s. This is especially possible when the starch is cationized in adhesive phase or alternatively when a step of reducing the molar mass of an already-cationized starch is performed in solvent phase.

As described previously, use may be made, to perform the process according to the invention, of a liquid starchy composition comprising a dissolved waxy cationic starch and one or more metal salts chosen from ferric salts and alumina salts, and the viscosity of said cationic waxy starch, measured according to test A, is greater than 100 mPa·s and less than 1000 mPa·s. This novel composition is another aspect of the present invention.

The viscosity of the cationic waxy starch, measured according to test A, is advantageously between 150 and 990 mPa·s, preferentially between 200 and 500 mPa·s and most preferentially between 205 and 450 mPa·s. According to a second variant of the invention, the cationic waxy starch has, according to test A, a viscosity ranging from 505 to 990 mPa·s, for example from 550 to 950 mPa·s.

Preferably, the pH of the composition according to the invention is between 0 and 7, for example between 1 and 5.

The composition advantageously has a cationic starch/metal salt mass ratio ranging from 15/85 to 70/30, for example from 15/85 to 60/40, advantageously from 15/85 to 55/45, preferentially from 20/80 to 50/50 and most preferentially from 25/75 to 40/60.

The metal salt is advantageously polyaluminum chloride or ferric chloride. In the case of ferric chloride, it is preferred for the cationic starch/metal salt ratio to be from 25/75 to 50/50, or even from 30/70 to 45/55. In the case of polyaluminum chloride, it is preferred for the cationic starch/metal salt ratio to be from 20/80 to 45/55, or even from 25/75 to 35/65.

Preferentially, the metal salt is an aluminum salt, especially a polyaluminum chloride. According to this preferred variant, the pH of the composition is most preferentially between 2 and 5.

The liquid composition according to the invention advantageously comprises as solvent water or an aqueous-alcoholic solution, preferentially water. In other words, it is stated that the solvent preferentially consists of water.

According to an advantageous variant of the invention, a liquid composition of cationic starch free of preserving agent is used.

When the cationic starch is in liquid form, degradation may be observed during its storage and the transportation of the product. To limit this phenomenon, a biocidal agent must generally be added, which may be chosen from phthalates, for example one of those sold by Röhm & Haas under the brand name Vinyzene™. Now, although the concentration of biocidal agent required for conservation of the starch in liquid solution form is low, these biocidal agents may constitute undesired constituents for the treatment of a water and most particularly for obtaining a drinking water. Now, it has been found that the composition according to the invention has entirely satisfactory stability over time, even in the absence of these conventionally used biocides. This stability is particularly good in the case where one or more aluminum salts are used as metal salts.

The cationic waxy starch that is useful in the invention has a Brookfield viscosity of greater than 100 mPa·s and less than 1000 mPa·s under the conditions of test A. The measurement of this viscosity, performed with a Brookfield® brand viscometer, is well known to those skilled in the art. In particular, various modules exist for measuring this viscosity and each module is adapted for a given viscosity range. It suffices to select the module that is adapted to the viscosity of the composition to be measured. By way of example, test A may be performed using the RV1 module at 20 rpm for a viscosity of greater than 100 mPa·s and less than or equal to 1000 mPa·s.

The liquid composition of the invention may take the form of a concentrated liquid composition, i.e. the solids content of said composition ranges from 10% to 80% and preferentially from 15% to 40%.

One advantage of this composition is that it is liquid at 25° C., while at the same time having a high solids content. This allows it to be transported and/or stored easily before use. It may be introduced directly into water or sludge treatment installations, this introduction generally being performed with the aid of meters. However, certain meters do not allow optimum metering when the solids content is high, and it is therefore occasionally difficult to use the composition according to the invention directly in said installations. As a result of its liquid form, dilution of this composition with a high solids content takes place very easily, by simple mixing with a solvent, especially by simple mixing with water. The liquid composition M can thus be readily formed after predilution of this concentrated liquid composition, it being recalled that said liquid composition M may, according to one variant of the process for making water drinkable of the invention, be added during step a) of the coagulation-flocculation step.

Due to its excellent capacity for coagulating solids in suspension, the composition according to the invention is useful for treating water or sludges, for example for dehydrating or thickening a sludge. The term “water to be treated” generally means an aqueous composition comprising water and matter in suspension, the amount of matter in suspension being less than 0.2% of the mass of the aqueous composition. The term “sludge to be treated” means, on the other hand, an aqueous composition comprising water and matter in suspension, the amount of matter in suspension being greater than or equal to 0.2% of the mass of the aqueous composition. The terms “water to be treated” and “sludge to be treated” include all types of urban effluents or of effluents derived from various industries, especially effluents derived from paper or starch factories.

Effluents derived from paper factories comprise, for example, coating slips, which are emulsions of polymers dispersed in an aqueous phase.

These emulsions must be destabilized (“broken”) in order to separate the aqueous phase, which is reusable in the process, from the organic phase. This is then referred to as breaking the emulsion. Furthermore, it is necessary for the breaking to be efficient since coating slips disrupt the biological treatments of sludges (“activated sludges”). It is thus necessary to break these emulsions before carrying out a biological treatment, in particular if the contents are high.

The composition according to the invention makes it possible, for the treatment of water or sludge, to reduce the turbidity of the water recovered after the treatment, and to reduce the COD or the phosphorus content. This makes it possible either to discharge the recovered water into the natural medium or to reuse it in the process.

The composition according to the invention is particularly effective for clarifying water, i.e. for reducing the amount of solids in suspension of an aqueous solution.

The use of the mixture according to the invention for treating water or sludge also has the advantage of greatly limiting the residual amount of metal salt when compared with conventional treatments based on metal salt used alone. Specifically, the Applicant has found that, for the same dose of metal salt introduced, the treated water contained three times less residual salt in the water obtained after treatment. The volume of sludges produced is also lower using the composition of the invention.

The composition according to the invention may be used for treating water or sludges, in combination with at least one other coagulant or alternatively with at least one flocculant.

Although other coagulants may be used in the process, this process may be performed without any other additional coagulant and/or flocculant, in particular without polyacrylamide and without clay.

The coagulation-flocculation step may be performed in a conventional manner.

During the first steps a) and b) of the coagulation-flocculation step, the particles are coagulated and the flocs are then formed in a coagulation-flocculation tank.

This tank may comprise a first basin known as the “coagulation basin” and a second basin known as the “flocculation basin”, in which the stirring speed is greater in the first than in the second. Advantageously, the starch composition and the metal salt are introduced into the coagulation basin.

In the case of a continuous process, the aqueous solution to be treated is introduced into said tank by means of a pump, which thus makes it possible to adjust the introduction flow rate. The duration of the coagulation-flocculation step then depends on this flow rate and on the volume of the tanks used. The salt and the starch that are useful in the invention may be mixed with the aqueous solution to be treated either prior to the introduction of this solution into the coagulation-flocculation tank, or directly into the tank via a second inlet provided for this purpose. The duration of this coagulation-flocculation step depends directly on the volume of the tank and on the chosen flow rate.

The water to be treated may optionally undergo a pretreatment to adjust its pH. Preferentially, the pH of the aqueous solution comprising solids in suspension ranges from 5 to 8.5.

To remove the flocs and thus be able to recover the purified water and perform the separation step c), use may be made, at will, of a decantation or a flotation technique. These techniques, which are well known to those skilled in the art, may be performed in standard water treatment installations.

Preferentially, a decantation of the flocs formed is performed in step c).

When this separation step is performed by decantation, an agent that is capable of ballasting the flocs formed, such as micrometric sand, may also be introduced into the coagulation-flocculation tank. These ballasted flocs are transferred with the aqueous solution into the decanter, which makes it possible to improve the rate of separation in the subsequent decantation step.

The decanter may be a static decanter or a lamellar decanter. The decanter may be equipped with a bottom scraper for better uptake of the decanted sludges.

The static decanter is the most conventional decanter: it consists of a single tank in which the coagulated particles become deposited at the bottom of the tank to form sludges, and the purified water that has undergone the decantation is recovered by overflow.

Lamellar decanters also make it possible to accelerate the decantation of the coagulated particles in comparison with the static decanters.

Following the coagulation-flocculation step, a subsequent purification step may advantageously be performed.

This may be, for example, a filtration step. As already outlined, the coagulation-flocculation step used in the process according to the invention is then particularly advantageous.

This water filtration step may be a microfiltration, ultrafiltration or nanofiltration step. Use is made for this of filters such as filters comprising sand, anthracite or even active charcoals. It is also possible to use organic polymer membranes, especially of polypropylene, polyacrylamide or polysulfone.

Filtration of the water by reverse osmosis using a semipermeable membrane so as to remove the solutes therefrom may also be performed.

A step of disinfection of the water may also be performed. Many techniques for disinfecting liquids exist. It may be performed using ozone, by treatment using ultraviolet radiation or alternatively by using chlorine dioxide.

At the end of the process, a drinkable water whose turbidity is advantageously less than 1 NTU is obtained.

Embodiments will now be detailed in the examples that follow. It is pointed out that these illustrative examples do not in any way limit the scope of the present invention.

### EXAMPLE 1

This example presents various processes comprising a coagulation-flocculation step that are not according to the invention. These examples make it possible to show the problems solved by the invention.

Products Used

“A”: comparative cationic starch solution whose Brookfield viscosity is, according to test A, 17 500 mPa·s. This solution “A” is obtained from a cationic starch (non-waxy potato base) with a DS of 0.16. This starch is soluble in water at 20° C.

“B”: comparative cationic starch solution whose

Brookfield viscosity is, according to test A, 53 000 mPa·s. This solution “B” is obtained from a cationic starch (waxy corn base) with a DS of 0.05.

This starch is insoluble in water at 20° C. and the solution is thus prepared by cooking a solution at 95° C. for 15 minutes.

These first two liquid starchy compositions A and B have a high viscosity. They cannot be in the form of a composition with a high solids content that is readily pumpable or dilutable.

“C”: comparative cationic starch solution whose Brookfield viscosity is, according to test A, 50 mPa·s. This solution “C” is obtained from a cationic starch (waxy corn base) which has undergone an acidic hydrolysis treatment, having a DS of 0.16. The solution is prepared by cooking a solution at 95° C. for 15 minutes.

This third starchy composition has a much lower viscosity. It has the advantage of being able to be in the form of a composition with a high solids content that is readily pumpable or dilutable.

FeCl₃: ferric chloride in solution.

The mixtures are evaluated by Jar-Test for the purpose of making drinkable a water taken from the river Lys (initial turbidity 65 NTU). 5 grams of sand (diameter<100 μm) are added to 1 L of water with stirring, and the mixture of coagulants is then added with stirring at 200 rpm for 3 minutes. The stirring is then stopped and the turbidity of the supernatant is measured after 3 minutes of decantation. The dose of coagulant used is 10 milligrams of active material per liter of water to be treated (mg/L).

Solutions A, B and C are tested as a mixture with FeCl₃, in a 45/55 starch/FeCl₃ mass ratio. The results obtained are collated in Table 1.

TABLE 1

| Solution combined | Turbidity of the | % reduction in |
|---|---|---|
| with FeCl₃ | supernatant (NTU) | turbidity |
| A | 0.7 | >99% |
| B | 0.8 | >99% |
| C | 2.5 | 97.5% |

The mixtures of metal salts with A and B are efficient and there is no difference whether the starch is a waxy starch or not. Solution C has the advantage of being very sparingly viscous, but its efficacy is insufficient.

### EXAMPLE 2

This example illustrates the invention using, in combination with a starch solution, an iron salt as metal salt.

“A”: solution identical to that of Example 1.

“D”: comparative cationic starch solution whose Brookfield viscosity is, according to test A, 350 mPa·s. This solution “D” is obtained from a non-waxy cationic starch (potato base), which has undergone an enzymatic hydrolysis treatment, having a DS of 0.16. This starch is soluble in water at 20° C.

“E”: cationic starch solution according to the invention, whose Brookfield viscosity is, according to test A, 210 mPa·s. This solution “E” is obtained from a cationic starch (waxy corn base), which has undergone an enzymatic hydrolysis treatment, having a DS of 0.05. This starch is soluble in water at 20° C.

“F”: cationic starch solution according to the invention, whose Brookfield viscosity is, according to test A, 810 mPa·s. This solution “F” is obtained from a cationic starch (waxy corn base), which has undergone an enzymatic hydrolysis treatment, having a DS of 0.05. This starch is soluble in water at 20° C.

The test protocol is identical to that of Example 1. The water used here is initially of 13 NTU, doped to 100 NTU by adding calcium carbonate (Mikhart 5).

The viscosity of solutions “A” and “E” at various concentrations is given in Table 2.

TABLE 2

Brookfield viscosity (mPa · s)

| Concentration (%) | Solution A | Solution E |
|---|---|---|
| 0.6 | 122 | Not measured |
| 3 | 1100 | Not measured |
| 5 | 3100 | 63 |
| 10 | 17 500 | 210 |
| 15 | 34 000 | 490 |
| 27 | Not measurable | 4500 |

Solutions A, D, E and F are tested as a mixture with FeCl₃, in a 40/60 starch/FeCl₃ dry/dry mass ratio. The results obtained are reported in Table 3.

TABLE 3

| Solution combined | Turbidity of the | % reduction in |
|---|---|---|
| with FeCl₃ | supernatant (NTU) | turbidity |
| A | 0.5 | 99% |
| D | 5.0 | 90% |
| E | 0.5 | 99% |
| F | 0.3 | 99% |

Solution “A” gives a satisfactory turbidity result, but its high viscosity does not make it possible to envisage marketing in concentrated form, as may be seen in Table 2. When the product undergoes an enzymatic treatment for the purpose of reducing its viscosity, it is possible to obtain solution “D”. However, this solution does not make it possible to reduce the turbidity satisfactorily during the coagulation-flocculation step. Unexpectedly, solution “E” based on enzymatically treated cationic waxy corn starch is very efficient in this same process, even though its viscosity is lower than that of “D”. This low viscosity allows it to be in the form of a composition with a high solids content, which is readily pumpable or dilutable. Solution “F” is, for its part, slightly less readily pumpable, but remains entirely manipulable. Furthermore, the reduction in turbidity is equivalent, or even slightly improved, relative to that of solution “E”.

### EXAMPLE 3

This example illustrates the invention by using, together with a starch solution, an aluminum salt as metal salt.

PAC: polyaluminum chloride

“G”: 70/30 by mass mixture of PAC and of A

“H”: 70/30 by mass mixture of PAC and of E

Mixtures “G” and “H” are evaluated by the Jar-Test for the purpose of making drinkable a water taken from the river Lys (initial turbidity 6 NTU). The water is charged with shoreline sludge to reach a turbidity of 50 NTU. The protocol is the same as in the preceding examples. The results obtained are collated in Table 4.

TABLE 4

| | Turbidity of the | % reduction in |
|---|---|---|
| Mixture tested | supernatant (NTU) | turbidity |
| G | 0.4 | 99.1% |
| H | 0.5 | 99.0% |

Mixture H is as effective as mixture G.

After storage for 2 months, mixture H has a stable viscosity and is just as effective in the process. It should be noted that, as in the case of the starchy solutions that are useful to the invention of Example 2, the mixture of metal salt and of solution E has a viscosity which allows it to be in the form of a composition with a high solids content, which is readily pumpable or dilutable.

### EXAMPLE 4

This example illustrates the invention by using, in combination with solution G described previously for the treatment of an effluent derived from a production of yeast.

Coagulation and then flocculation treatments are performed after a methanization and activated sludge treatment, so as to ensure dephosphatation of the effluent. This treatment is then followed by the decantation of the flocs formed.

The tests are performed in a Jar-Test according to the following protocol:
coagulation: 3 minutes at 200 rpm
flocculation: 17 minutes at 40 rpm
decantation: 10 minutes

Besides the turbidity and the color of the effluent, the chemical oxygen demand (COD) and the phosphorus (P) content are also monitored.

The water before treatment has a turbidity of 7 NTU, a color of 0.45 measured at 254 nm, a chemical oxygen demand (COD) of 60 mg/L and a phosphorus (P) content of 0.27 mg/L.

In the reference test, the coagulation is performed by adding to the effluent 40 ppm (as dry matter) of FeCl₃, whereas the flocculation is performed using an anionic polyacrylamide (A-PAM 1.4 ppm).

In the test according to the invention, the process is identical except that the coagulation is performed by replacing the 40 ppm of FeCl₃ (as dry matter) with 40 ppm of the PAC/cationic starch mixture of solution H.

The water obtained by treatment with the reference products is compared with that obtained by treatment with solution H described in the preceding example, supplemented with A-PAM, at the same doses as in the reference test.

The results are given in Table 5.

TABLE 5

| Coagulant | Turbidity (NTU) | Color | COD (mg/L) | P (mg/L) |
|---|---|---|---|---|
| FeCl₃ | 1.1 | 0.38 | 49 | 0.010 |
| Solution H | 0.6 | 0.34 | 42 | 0.006 |

With the same dose, solution H makes it possible to obtain a lower turbidity, a lower COD and a lower phosphorus content, and also an equivalent color.

### EXAMPLE 5

This example illustrates the invention by treating an effluent derived from a coated paper production, for the breaking of the emulsion. The coagulation-flocculation treatment is usually performed with a PAC so as to obtain the lowest possible turbidity and chemical oxygen demand (COD).

These tests are performed by the Jar-Test with stirring at 200 rpm for 3 minutes followed by decantation for 10 minutes. Solution E is used in combination with a PAC in various doses, and the results are given in Table 6.

TABLE 6

| Dose of solution | Dose of PAC | | |
|---|---|---|---|
| E (ppm of dry | (ppm of dry | Turbidity | COD |
| matter) | matter) | (NTU) | (mg/L) |
| 100 | 0 | 2000 | >160 |
| 80 | 20 | 224 | >160 |
| 60 | 40 | 28 | 41 |
| 40 | 60 | 15 | 28 |
| 20 | 80 | 11 | 20 |
| 0 | 100 | 34 | 22 |

Solution E used alone is ineffective and does not make it possible to break the emulsion, unlike PAC alone.

On the other hand, the combined use of the two coagulants, particularly in a cationic starch/metal salt mass ratio ranging from 15/85 to 70/30 and especially from 20/80 to 50/50, gives better results than the use of PAC alone, more especially as regards the turbidity.

1. A process for making drinkable an aqueous solution having solids in suspension, containing a coagulation-flocculation step, characterized in that said step comprises:
a) a step of adding coagulants to the aqueous solution to be treated;
b) a step of stirring the aqueous solution thus supplemented;
c) a step of separating out the coagulated solids by decantation or flotation;
d) a step of recovering a purified water;
and in which the coagulants added in step a) comprise metal salts chosen from ferric salts and aluminum salts and also a liquid starchy composition comprising a cationic waxy starch, said cationic waxy starch having, when it is in the form of an aqueous composition, a viscosity, measured according to a test A, of greater than 100 mPa·s and less than 1000 mPa·s, this test A consisting in adjusting the solids content of cationic waxy starch dry mass the aqueous composition to 10% and then in measuring the Brookfield viscosity at 25° C. of the resulting composition.

2. The process as claimed in claim 1, characterized in that the salts and the liquid starchy composition are added separately in step a).

3. The process as claimed in claim 1, characterized in that the salts and the liquid starchy composition are added simultaneously in step a).

4. The process as claimed in claim 1, characterized in that the salts and the liquid starchy composition are added in step a) by means of a liquid composition M comprising both the dissolved cationic starch and the salts.

5. The process as claimed in claim 1, characterized in that the viscosity of the cationic starch, measured according to test A, is between 150 and 990 mPa·s.

6. The process as claimed in claim 5, characterized in that the viscosity of the cationic starch, measured according to test A, is between 200 and 500 mPa·s, for example between 205 and 450 mPa·s.

7. The process as claimed in claim 1, characterized in that the total mass amount of cationic starch and of metal salt in the aqueous solution ranges from 1 to 500 mg/L of water to be treated and preferentially from 5 to 10 mg/L.

8. The process as claimed in claim 1, characterized in that the cationic starch/metal salt mass ratio ranges from 15/85 to 70/30 and preferentially from 20/80 to 50/50.

9. The process as claimed in claim 1, characterized in that the turbidity of the purified water obtained after step e) is less than or equal to 1.5 NTU and preferentially less than 1 NTU.

10. A liquid composition which may be used in the process as claimed in claim 1, comprising a dissolved cationic waxy starch and one or more metal salts chosen from ferric salts and aluminum salts, characterized in that said cationic starch has, when it is in the form of an aqueous composition, a viscosity, measured according to a test A, of greater than 100 mPa·s and less than 1000 mPa·s, this test A consisting in adjusting the dry mass of cationic waxy starch of the aqueous composition to 10% and then in measuring the Brookfield viscosity at 25° C. of the resulting composition.

11. The composition as claimed in claim 10, characterized in that the viscosity of the cationic starch, measured according to test A, is between 150 and 990 mPa·s, preferentially between 200 and 500 mPa·s, for example between 205 and 450 mPa·s.

12. The composition as claimed in claim 10, characterized in that the metal salt is an aluminum salt, especially a polyaluminum chloride.

13. The composition as claimed in claim 10, characterized in that the cationic starch/metal salt mass ratio ranges from 15/85 to 70/30 and preferentially from 20/80 to 50/50.

14. The composition as claimed in claim 10, characterized in that it has a pH of between 0 and 7, for example between 1 and 5.

15. The composition as claimed in claim 10, characterized in that the solids content of said composition ranges from 10% to 80% and preferentially from 15% to 40%.

16. The process as claimed in claim 1, wherein the aqueous solution having solids in suspension is water or sludges.

17. The process as claimed in claim 16, wherein the process yields clarified water.
